(19) United States
(12) Patent Application Publication
(10) Pub. No.: US 2024/0169368 A1
(43) Pub. Date: May 23, 2024

(54) Method and System for Determining Carbon Dioxide Emission Value of Grading by Website

(71) Applicant: Everything Green Limited, Hong Kong (HK)

(72) Inventor: Vishwas Thakkar, Hong Kong (CN)

(21) Appl. No.: 18/549,184

(22) PCT Filed: Dec. 24, 2022
(86) PCT No.: PCT/CN2022/141729

§ 371 Date: Sep. 6, 2023

(30) Foreign Application Priority Data
Dec. 24, 2021 (HK) 32021045232.4

(51) Int. Cl. G06Q 30/018

(52) U.S. Cl. CPC G06Q 30/018

(57) ABSTRACT

The present invention relates to computer implemented system and method for determining a carbon dioxide emission value or grading of a website, comprising the steps of determining an average number of bytes of data processed by the website; determining an estimated energy consumption based on the data processed; and deriving an estimated amount of carbon dioxide emission from the estimated energy consumption; and providing a value or grading based on the estimated amount of carbon dioxide emission.

### FIELD OF THE INVENTION

The invention relates to power consumption in the field of information and communications technology (ICT) and particularly, power consumption and its impact to the environment by the transfer of data by websites.

### BACKGROUND OF THE INVENTION

With the continuously increasing demands on information and communication technology (ICT) devices such as smartphones, tablet computers and other mobile computing devices, as well as the growing popularity of the “internet-of-things” technologies which connect various aspects of one's modern life with the internet, there exists an explosive growth on electricity consumption by the ICT sector. From data centers where the digital information are stored, transmission and communication networks, to computing or mobile devices in every daily applications, the internet and the related digital tools all consume electricity energy and therefore, are responsible for the rising of carbon dioxide emission.

For example, the article “On Global Electricity Usage Of Communication Technology: Trends to 2030” (Anders S. G. Andrae and Tomas Edler, Challenges 2015, 6, 117-157) provides an energy forecast of about 21% increase in the projected electricity demand in the field of ICT from 2010 to 2030. The Nature article “How to stop data centres from gobbling up the world's electricity” (Nicola Jones, Nature, 13 Sep. 2018) also indicates an exponential growth on internet traffic from 2 terabyte (TB, 10¹² bytes) in 1987 to 1.1 zettabyte (ZB, 10¹⁸ bytes) in 2017. The increasing reliance on digital tools and the internet therefore imposes constantly growing demand on power consumption and thus impact to the environment, including carbon dioxide emission.

In order to reduce the carbon footprint from the use of digital technologies, it is important to understand the amount of energy the digital tools and particularly, the traffic of data via these digital tools, may consume. For example, it has been shown that streaming moving images is one serious cause of carbon emissions in the digital world. In addition to videos and moving images streaming, websites can be another cause having an impact on carbon emissions. It is suggested that an average website produces about 4.61 grams of carbon dioxide for every page view. For a website having an average of 10,000 page views per month, it may generate 553 kilograms of carbon dioxide in a year. It is therefore desired to provide a tool to estimate, or at least to provide an indication on the carbon footprint due to one's digital use of a website.

### OBJECTS OF THE INVENTION

An object of the invention is to provide a novel solution for determining carbon dioxide emission from data transmission by a website.

Another object of the invention is to mitigate or obviate to some degree one or more problems associated with known solutions in the prior art.

The above object is met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a computer implemented method of determining a carbon dioxide emission value or grading of a website. The method comprises the steps of (a) determining an average number of bytes of data processed by the website; (b) determining an estimated energy consumption based on the data processed; and (c) deriving an estimated amount of carbon dioxide emission from the estimated energy consumption; and (d) providing a value or grading based on the estimated amount of carbon dioxide emission.

In a second main aspect, the invention provides a system for determining a carbon dioxide emission value or grading of a website. The system comprises a data module for determining an average number of bytes of data processed by a website; an energy module for determining an estimated energy consumption based on the number of bytes of data processed; a carbon dioxide emission module for deriving an estimated amount of carbon dioxide emission resulting from generation of the estimated energy consumption; and a valuation or grading module for providing a value or grading to the website based on the derived estimated amount of carbon dioxide emission.

In a third main aspect, the invention provides a non-transitory computer readable medium storing machine-readable instructions which, when executed on a processor, implement the steps of the first main aspect of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a block schematic diagram of a system for determining a carbon dioxide emission value or grading by a website in accordance with an embodiment of the present invention; and

FIG. 2 is a flow diagram showing the method steps implemented by the system of FIG. 1.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the figures may be implemented in various forms of hardware, software or combinations thereof. These elements may be implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

The invention generally relates to a method and a system that allows for determining a carbon dioxide emission value or a grading on carbon dioxide emission of a website, and particularly, to determine a carbon dioxide emission value or grading based on the transmission of data when loading a website. The value or grading of carbon dioxide emission provides an indication on the level of power consumption by the process and thus, the eco-friendliness of the website.

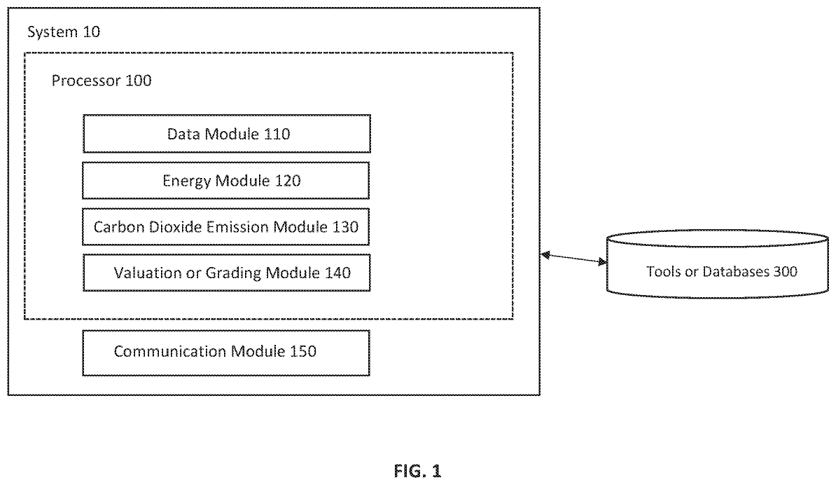

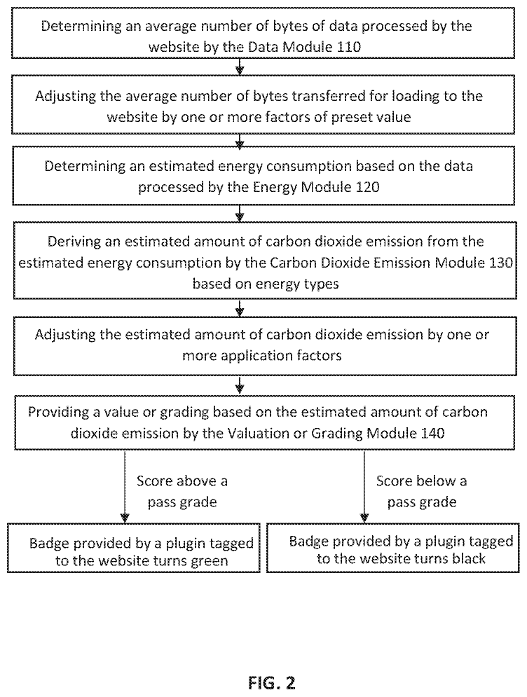

FIG. 1 shows an exemplary embodiment of a system 10 in accordance with concepts of the present invention, and FIG. 2 shows the embodied method steps implemented by the system 10. Without limited by the specific embodiments described and illustrated, the system 10 can be provided in the form of any software such as a computer program, platform or application, etc. Alternatively, the system 10 can be implemented at, provided as, or configured to comprise a computer processing device comprising a processor 100 for executing computer readable instructions to implement the method steps of the present invention. In another embodiment, the elements as described and shown can be implemented in or as various forms of hardware, software or combination thereof. In the context of the present invention, the terms “computer”; “computer device”, “computer processing device”, “processor”, “processing device” are intended to encompass any suitable processing device. For example, any components, systems or devices described herein can be associated with any computer or processing devices such as general-purposed computers, client terminals, or other suitable devices such as mobile phones, smart phones, tablets, smart watches, or any other mobile computing devices.

In one embodiment, the system 10 may comprise, or executed via a processor 100 which comprises, a plurality of functional blocks for performing various functions thereof. For example, the system 10 may comprise a data module 110 for determining an average number of bytes of data processed by a website; an energy module 120 for determining an estimated energy consumption based on the number of bytes of data processed; a carbon dioxide emission module 130 for deriving an estimated amount of carbon dioxide emission resulting from generation of the estimated energy consumption; and a valuation or grading module 140 for providing a value or grading to the website based on the derived estimated amount of carbon dioxide emission. Details of the respective modules will be discussed further below.

Particularly, the system 10 is adapted to determine, via the data module 110, the amount of data transferred, such as an average number of bytes of data processed by a website. More particularly, the average number of bytes of data processed by the website may comprise an average number of bytes transferred to load the website, either to load the website partially or fully. In one embodiment, the total number of bytes transferred to fully load the website is considered. Preferably, the amount of data transfer, i.e. the number of bytes processed on page loaded is obtained, derived and/or calculated from data of existing automated tools, programs or application programming interfaces (API) 300, such as but is not limited to Google Lighthouse (https://developers.google.com/web/tools/lighthouse) and/or other existing tools or database 300. In one embodiment, the communication between the data module 110 and the Google Lighthouse program can be facilitated by a communication module 150 which can be a functional block of the software of system 10 or as a structural component of the processor 100.

To accommodate different use scenarios where the website might be cached from previous visits or the website is first visited by the user, it is preferred to adjust the average number of total bytes transferred for loading to the website by one or more factors of preset values. For example, the factors may comprise a factor for data loaded by visiting the website for the first time, a factor for a return visit to the website, and a factor for a certain percentage of data loaded on a subsequent loading of the website. In one specific embodiment, the factor for data loaded by visiting the website for the first time can be set as 0.25, the factor for a return visit to the website can be set as 0.75, and the factor for a certain percentage of data loaded on a subsequent loading of the website can be set as 0.02, for example. These factors can be used to adjust the average number of total bytes transferred according to the respective use cases.

Based on the determined and preferably, adjusted total number of bytes transferred to load the website, the energy module 120 is then adapted to determine an estimated energy consumption. To load by transferring data to and from a website page, energy will be consumed at the data center, communication or transmission networks as well as by the device of the end users. The amount of energy consumes vary for every websites and for every visitors, but for the purpose of estimation, the inventor has obtained a total amount of energy used as referenced for the year 2017 in the article “On Global Electricity Usage Of Communication Technology: Trends to 2030” (Anders S. G. Andrae and Tomas Edler, Challenges 2015, 6, 117-157), and has divided the number by a total annual data transfer over the web of the same year as reported in the Nature article “How to stop data centres from gobbling up the world's electricity” (Nicola Jones, Nature, 13 Sep. 2018). This gives a figure on the average energy intensity per data transferred of 1.805 kWh/GB. Accordingly, an estimated energy consumption to load a website can be calculated by the equation:

Estimated energy consumption=Average number of byte of data transferred×1.805 kWh/GB

where the estimated energy consumption relates to the estimated energy consumption to load a page or a website, and the average number of byte of data transferred relates to the average number of byte of data transferred to load the same page or website.

Once the estimated energy consumption is determined, it is possible to derive an estimated amount of carbon dioxide emission based on the estimated energy consumption. To do so, reference has been made to an international average on carbon dioxide intensity per energy consumed based on International Energy Agent (IEA). For example, an average carbon dioxide intensity per energy consumed based on fuel-derived energy can be referenced as 475 g per kWh, and an average carbon dioxide intensity per energy consumed based on renewable energy can be referenced as 33.4 grams per kWh.

The estimated amount of carbon dioxide emission may further be adjusted by taking into account one or more application factors, for example, whether the energy is consumed at/by data centres, communication networks and/or users' devices. For example, the energy consumed at/by data centres can be assumed to attribute to about 10.08% of the total energy consumption, and the energy consumed by communication network and users' devices can be assumed to attribute to about 89.92% of the total energy consumption.

In one embodiment, if the energy is consumed by a green server, that is a data centre powered by renewable energy, the estimated amount of carbon dioxide emission (CO₂e) can be calculated by the equation:

CO₂e=(Estimated energy consumption x Percentage of energy consumed by data center) x average carbon dioxide intensity per energy consumed based on renewable energy+(Estimated energy consumption×Percentage of energy consumed by communication networks and users' devices)×average carbon dioxide intensity per energy consumed based on fuel-derived energy

In another embodiment, if the server is not running on green energy, that is, the data centre is powered by fuel-derived energy, the estimated amount of carbon dioxide emission (CO₂e) can be calculated by the equation:

CO₂e=Estimated energy consumption x average carbon dioxide intensity per energy consumed based on fuel-derived energy

Once the estimated amount of carbon dioxide emission is derived based on the calculation, the next step is to provide a grading based on the estimated amount of carbon dioxide emission. Preferably, the grading can be provided in the form of a score. The calculation of score is based on the assumption on a set number of preset carbon dioxide emission values, such as

CO₂e Values=[0.5, 1.0, 1.76, 2.0, 2.5] grams,

and a set number of preset scoring values set in accordance with the set number of preset carbon dioxide emission values, such as

Score Values=[90, 75, 70, 50, 25].

The score can be calculated by first determining an upper-bound carbon dioxide emission value and a lower-bound carbon dioxide emission value comprising the derived estimated amount of carbon dioxide emission. For example, if the estimated amount of carbon dioxide emission is 2.3 grams, the upper-bound carbon dioxide emission value and the lower bound carbon dioxide emission value will be 2.5 and 2.0, respectively.

Then an upper-bound scoring value correspond to the upper-bound carbon dioxide emission value, and a lower-bound scoring value correspond to the lower-bound carbon dioxide emission value will be determined. For example, with the upper-bound carbon dioxide emission value being 2.5 and the lower bound carbon dioxide emission value being 2.0. The upper-bound scoring value and the lower-bound scoring value will be determined as 25 and 50, respectively.

The score can then be calculated based on the equation:

$$Score = upper - bound scoring value + ( lower - bound scoring value - upper - bound scoring value ) \text{} / ( upper - bound carbon dioxide emission value - lower - bound carbon dioxide emission value ) \times ( upper bound carbon dioxide emission value - the estimated amount of carbon dioxide emission ) = 25 + ( ( 50 - 25 ) / ( 2.5 - 2 ) ) \times ( 2.5 - 2.3 ) = 35$$

In another example, if the estimated amount of carbon dioxide emission is 0.4 grams, the upper-bound carbon dioxide emission value and the lower bound carbon dioxide emission value will be 0.5 and 0, respectively; and the corresponding upper-bound scoring value and lower-bound scoring value will be 90 and 100, respectively. Accordingly, the score for this specific carbon dioxide emission can be calculated as:

Score=90+((100−90)/(0.5−0))×(0.5−0.4)=92

Further assumption can be made by setting the score to 1 if the calculated score is negative, and setting the score to 99 if the calculated score is large than or equal to 100.

In one embodiment, a plugin can be tagged to the website after the valuation or grading. Particularly, the plugin may provide a score-indicating grading to the website. For example, the plugin can be configured to indicate one or more colors representing the calculated score, or, when a change of score is detected from the same website, a change of color can be shown to represent the change of score. Preferably, the color can be represented in the form of a sign or a badge visible by all visitors to the website or specific visitors to the website. In one embodiment, the plugin can further be configured to monitor the website by sending the website to the system 10 again and to actuate the above-described method steps on a regular basis, such upon reloading of the website, to thereby confirm if there is any change of score and thus change of color of the badge. For example, the badge may change from the color green to black if the calculated score of the website has dropped below a pass grade, such as 75, which may prompt the website owner to take corresponding corrective actions.

In another embodiment, an extension can be provided to a browser of the user for reviewing browsing history of the browser and then actuating the relevant steps to determine carbon emission values or gradings of one or more websites from the browsing history. The extension assists to provide an indication for users who are interested to know how much the websites they are using are responsible for carbon emissions. For example, the extension can be added by the user to their browsers to regularly actuate the above-described steps to determine the carbon dioxide emissions. The extension may further enable the badge of specific websites be visible to users whose browsers have been installed with the extension.

The present invention may further relate to a non-transitory computer readable medium storing machine-readable instructions which, when executed on a processor 100, implement the steps of method as described above.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A computer implemented method of determining a carbon dioxide emission value or grading of a website, comprising the steps of :
(a) determining an average number of bytes of data processed by the website;
(b) determining an estimated energy consumption based on the data processed; and
(c) deriving an estimated amount of carbon dioxide emission from the estimated energy consumption; and
(d) providing a value or grading based on the estimated amount of carbon dioxide emission.

2. The computer implemented method according to claim 1, wherein the average number of bytes of data processed by the website comprises an average number of total bytes transferred for loading to the website.

3. The computer implemented method according to claim 2, wherein step (a) comprises adjusting the average number of total bytes transferred for loading to the website by one or more factors of preset values, the factors comprising a factor for data loaded by visiting the website for the first time, a factor for a return visit to the website, and a factor for a certain percentage of data loaded on a subsequent loading of the website.

4. The computer implemented method according to claim 3, wherein step (b) comprises multiplying the average number of bytes of data processed by the website with an average energy intensity per data transferred.

5. The computer implemented method according to claim 4, wherein step (c) comprises multiplying the estimated energy consumption with an average carbon dioxide intensity per energy consumed.

6. The computer implemented method according to claim 5, wherein the average carbon dioxide intensity per energy consumed comprises average carbon dioxide intensity per energy consumed based on fuel-derived energy, and/or average carbon dioxide intensity per energy consumed based on renewable energy.

7. The computer implemented method according to claim 6, wherein step (c) comprises adjusting the estimated amount of carbon dioxide emission by one or more application factors, the application factors comprising energy use by data centres, energy use by communication networks and energy use by user's devices.

8. The computer implemented method according to claim 7, wherein step (c) comprises multiplying the estimated energy consumption with an average carbon dioxide intensity per energy consumed and the one or more application factors.

9. The computer implemented method according to claim 8, wherein step (d) comprises the steps of:
determining an upper-bound carbon dioxide emission value and a lower-bound carbon dioxide emission value comprising the derived estimated amount of carbon dioxide emission; wherein the upper-bound carbon dioxide emission value and the lower-bound carbon dioxide emission value are selected from a set number of preset carbon dioxide emission values;
determining an upper-bound scoring value correspond to the upper-bound carbon dioxide emission value, and a lower-bound scoring value correspond to the lower-bound carbon dioxide emission value; wherein the upper-bound scoring value and the lower-bound scoring value are selected from a set number of scoring values preset in accordance with carbon dioxide emission values; and
calculating a score based on the equation:
Score=upper-bound scoring value+(lower-bound scoring value−upper-bound scoring value)/(upper-bound carbon dioxide emission value−lower-bound carbon dioxide emission value)×(upper bound carbon dioxide emission value−the estimated amount of carbon dioxide emission)

10. The computer implemented method according to claim 9, wherein the set number of preset carbon dioxide emission values comprise sequentially 0.5 grams, 1 gram, 1.76 grams, 2 grams and 2.5 grams.

11. The computer implemented method according to claim 10, wherein the set number of scoring values comprises sequentially 90, 75, 70, 50 and 25.

12. The computer implemented method according to claim 9, further comprising the step of tagging a plugin to the website to provide a score-indicating grading to the website.

13. The computer implemented method according to claim 12, where the plugin is adapted to indicated one or more colors representing the calculated score and/or a change of score.

14. The computer implemented method according to claim 12, wherein the plugin is adapted to actuate the step of claim 1 upon reloading the website.

15. The computer implemented method according to claim 9, further comprising the step of providing an extension to a browser, wherein the extension is adapted to review browsing history of said browser and actuate the step of claim 1 based on one or more websites from the browsing history.

16. A system for determining a carbon dioxide emission value or grading of a website, comprises:
a data module for determining an average number of bytes of data processed by a website;
an energy module for determining an estimated energy consumption based on the number of bytes of data processed;
a carbon dioxide emission module for deriving an estimated amount of carbon dioxide emission resulting from generation of the estimated energy consumption; and
a valuation or grading module for providing a value or grading to the website based on the derived estimated amount of carbon dioxide emission.

17. The system according to claim 16, further comprising a processor comprising the data module, the energy module, the carbon dioxide emission module and the valuation or grading module, wherein the processor is adapted to implement the method steps of claim 1.
